(19) United States
(12) Patent Application Publication
(10) Pub. No.: US 2002/0124214 A1
(43) Pub. Date: Sep. 5, 2002

(54) Method and system for eliminating duplicate reported errors in a logically partitioned multiprocessing system

(75) Inventors: George Henry Ahrens JR., Pflugerville, TX (US); Douglas Marvin Benignus, Dime Box, TX (US); Leo C. Mooney, Cedar Park, TX (US); Arthur James Tysor, Buda, TX (US)

Correspondence Address: SAWYER LAW GROUP, P.O. Box 51418, Palo Alto, CA, 94303, US

(73) Assignee: International Business Machines Corporation, Armonk, NY (US)

(21) Appl. No.: 09/798,207

(22) Filed: Mar. 1, 2001

(51) Int. Cl. G06F 11/32; G06F 11/30

(52) U.S. Cl. 714/57

(57) ABSTRACT

A method and system for eliminating duplicate reported errors in a logically partitioned multiprocessing system is disclosed. The method and system comprise providing a single source for receiving a plurality of related globally reported errors; and filtering the plurality of related globally reported errors such that only one call for service is provided. Accordingly, through the use of a system and method in accordance with the present invention when a global fault is reported by several OS partitions only one call for service is initiated from the hardware console. In so doing, a service representative will not make repeated calls for the same reported fault. Moreover, in the case that a different service representative is responsible for different partitions only one of the representatives will respond to the fault report.

### FIELD OF THE INVENTION

The present invention relates generally to logically partitioned multiprocessing systems and more particularly to eliminating duplicate reported errors in such a system.

### BACKGROUND OF THE INVENTION

Logical partitioning is the ability to make a single multiprocessing system run as if it were two or more independent systems. Each logical partition represents a division of resources in the system and operates as an independent logical system. Each partition is logical because the division of resources may be physical or virtual. An example of logical partitions is the partitioning of a multiprocessor computer system into multiple independent servers, each with its own processors, main storage, and I/O devices.

In a logically partitioned system, local errors (I/O adapters for that partition only) are reported on to the OS running on that partition. Global errors (errors that could affect all partitions, e.g., fan, power supply, memory, etc.) get reported to all operating systems. Currently when repairs are made, even Global repairs, the repair action is only recorded in the error log for the partition having the error. It would be advantageous to report the repair to all partitions, without the need to repetitively enter the repair data in each partition's log. The solution is to access the firmware diagnostics, which covers all partitions and have it enter global errors in the logs of all partitions.

FIG. 1 is a block diagram of a logically partitioned LPAR multiprocessing system 100. The multiprocessing system 100 includes a plurality of operating system (OS) partitions 102a, 102b, 102c and 102d which receive inputs locally from a plurality of input/output devices (IOs) 104 and globally from base hardware 106, for example, a power supply, a cooling supply, a fan, memory, and processors. Although four OS partitions are shown herein one of ordinary skill in the art readily recognizes any number of partitions can be utilized within the spirit and scope of the present invention. Each of the OS partitions 102a-102d include an identification (id) number 105a-105d.

In an LPAR multiprocessing system 100, there are a class of errors (Local) that are only reported to the assigned or owning partition's operating system. Failures of I/O adapters which are only assigned to a single partition's operating system are an example of this. There is also another class of errors (Global) that get reported to each partition's operating system because they could potentially affect each partition's operation. Examples of this type are power supply, fan, memory, and processor failures.

It is desirable to report a repair action on a global resource that is recorded in the error log on one partition to the error logs in all of the other partitions that share the resource. The partitions are isolated from one another so there is no knowledge of any other partition's error log information. If a hardware error is logged that requires a service action, diagnostics will continue to report the problem until a log repair action is logged. In the conventional LPAR multiprocessing system, each OS partition that shares the “repaired” resource must be visited (by either running diagnostics in system verification mode or using the log repair action service aid) to manually record the repair action or the global resource will continue to be reported as a problem in those partitions and not in the partition where the repair action was recorded. This adds significant time and customer disruption to every repair action for globally reported errors. Because of the globally reported errors, there is a need from a service perspective to be able to consolidate the error reports from each of the reporting OS partitions for tracking, reporting to service, and repair purposes.

Accordingly, what is needed is a system and method for reducing the amount of time required to report global errors and eliminate duplicate reports.. The system and method should be cost effective, easily implemented and readily adaptable to existing systems. The present invention addresses such a need.

### SUMMARY OF THE INVENTION

A method and system for eliminating duplicate reported errors in a logically partitioned multiprocessing system is disclosed. The method and system comprise providing a single source for receiving a plurality of related globally reported errors; and filtering the plurality of related globally reported errors such that only one call for service is provided.

Accordingly, through the use of a system and method in accordance with the present invention when a global fault is reported by several OS partitions only one call for service is initiated from the hardware console. In so doing, a service representative will not make repeated calls for the same reported fault. Moreover, in the case that a different service representative is responsible for different partitions only one of the representatives will respond to the fault report.

### BRIEF DESCRIPTION OF THE DRAWINGS

FIG. 1 is a block diagram of a logically partitioned multiprocessing system.

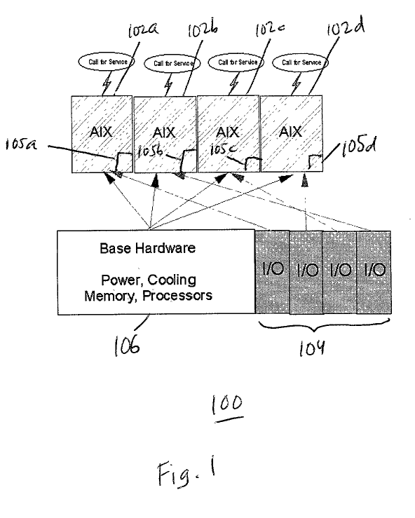

FIG. 2 is a diagram of a service focal point application in accordance with the present invention.

FIG. 3 is a flow chart which illustrates a process for minimizing duplicate reported errors in an LPAR multiprocessing system in accordance with the present invention.

FIG. 4 is a flow chart illustrating a preferred embodiment of a filtering mechanism in accordance with the present invention.

### DETAILED DESCRIPTION

The present invention relates generally to logically partitioned computer systems and more particularly to filtering error logs. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

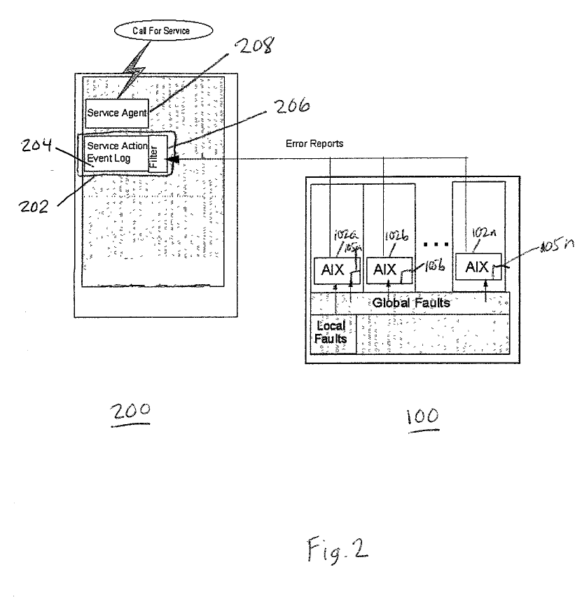

The present invention uses a procedure within a service focal point application within a hardware system console to minimize the number of globally reported failures. FIG. 2 is a diagram of a service focal point application in accordance with the present invention. In this system a service focal point application 202 resides on a hardware system console 200. The hardware system console includes a processor (not shown) that runs the SFP application 202. The SFP application 202 typically resides on a computer readable medium such as a floppy, disk drive, CD ROM, DVD, or the like. The service focal point application 202 includes a service action event (SAE) log 204 which receives error reports from the OS partitions 102a-102n via a filter 206. The service agent application 208 receives filtered information concerning the error reports and issues calls for service. As is seen, in the LPAR multiprocessing system there are global faults which are provided from each of the operating systems 102a-102n along with local faults that can be provided from each partition. Each of the OS partitions 102a-102n upon receiving a global fault will send an error report to the service focal point application in the hardware system. To describe the operation of the present invention in more detail, refer now to the following discussion in conjunction with the accompanying figures.

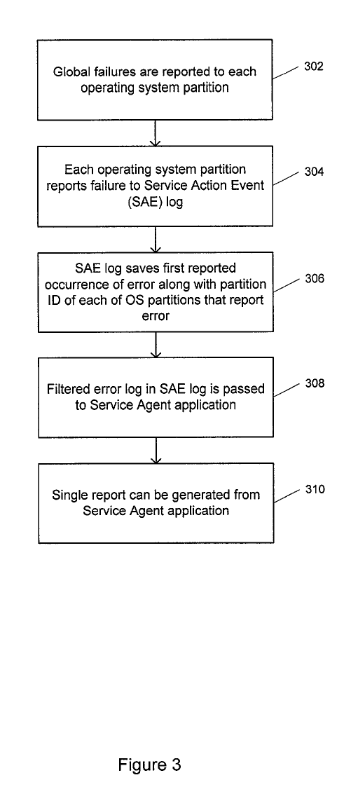

FIG. 3 is a flow chart which illustrates a process for minimizing duplicate reported errors in an LPAR multiprocessing system in accordance with the present invention. Referring now to FIGS. 2 and 3 together, globally reported failures are reported to each OS partition 102a-102n, via step 302. In turn, each operating system partition reports the failure to the SAE Log 204 in the SFP application 202, via step 304. The SAE log 204 includes a filtering mechanism (206) to filter replicated error logs from the OS partitions 102a-102n.

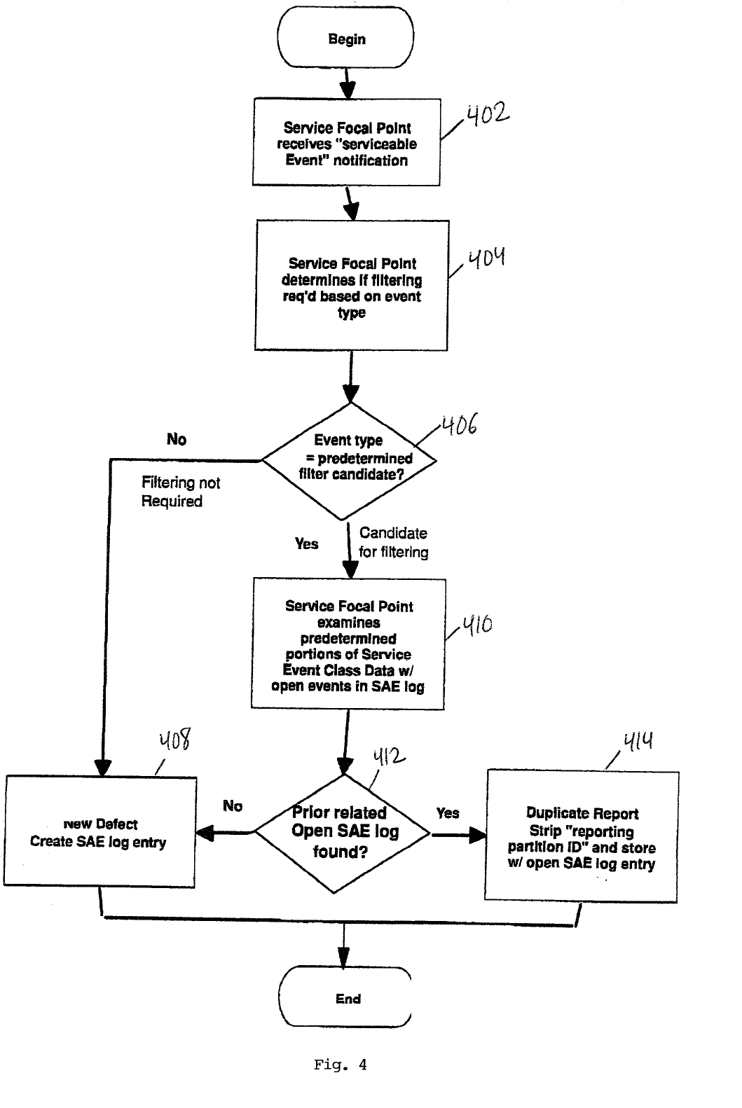

In a preferred embodiment, the filtering mechanism is provided via a software algorithm. FIG. 4 is a flow chart illustrating a preferred embodiment of a filtering mechanism in accordance with the present invention. First, the SFP application 202 receives “serviceable Event” notification, via step 402. Next the SFP application 202 determines if filtering is required based on an event type, via step 404. Next, it is determined if the event type equals a predetermined filter candidate, via step 406. If not, the event filtering is not required the fault is determined to be a new defect and an SAE log entry is created via step 408.

If the event is equal to a filter candidate, then the event is a candidate for filtering. Thereafter, SFP examines a predetermined portion of the Service Event Class Data with open events in the SAE log, via step 410. Then it is determined if a prior related Open SAE log is found, via step 412. If the log is not found, a new SAE log entry is created, via step 408. If the log is found, the event is a duplicate report, and the reporting partition ID is stripped and stored with an open SAE log entry, via step 414.

Accordingly, in an example of the filtering mechanism, for reported errors by an AIX operating system, filter 206 will interrogate the “error code” and “Location code” fields of the Service Event Class data. If the error and location codes compare exactly with an open SAE event, then the partition ID from the new SAE log request is stripped from the class data and saved with the open SAE log entry. If the comparison does not exactly match an open SAE log entry, then the reported error is new and a new SAE Log entry is opened requesting service.

Referring back to FIG. 3, after filtering occurs, the SAE log 204 then saves the first reported occurrence of the error along with the partition IDs 105a-105n of each of the OS partitions 102a-102n that reported the error for later use by the service representative, via step 306. The filtered error log in the SAE Log is then passed to the Service Agent application, via step 308. The Service Agent application (208) then sends a single report to a service representative for a call for service, via step 310.

Accordingly, through the use of a system and method in accordance with the present invention when a global fault is reported by several OS partitions only one call for service is initiated from the hardware system console. In so doing, a service representative will not make repeated calls for the same reported fault. Moreover, in the case that a different service representative is responsible for different partitions only one of the representatives will respond to the fault report.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for eliminating duplicate reported errors in a logically partitioned (LPAR) multiprocessing system, the method comprising the steps of:
(a) providing a single source for receiving a plurality of related globally reported errors; and
(b) filtering the plurality of related globally reported errors such that only one call for service is provided.

2. The method of claim 1 wherein filtering step (b) comprises the steps of:
(b1) receiving the plurality of related globally reported errors from the LPAR multiprocessing system;
(b2) saving a first occurrence of the plurality of related globally reported errors; and
(b3) sending the first occurrence to a service agent.

3. The method of claim 2 wherein the saving step (b2) further comprises the step of:
(b21) saving an identification of each partition that has reported a failure.

4. The method of claim 1 wherein the filtering step (b) comprises the steps of:
(b1) interrogating a plurality of fields of a service event data;
(b2) determining if the fields match an open SAE event; and
(b3) stripping a partition identifier from the data.

5. A system for eliminating duplicate reported errors in a logically partitioned (LPAR) multiprocessing system, the system comprising:
a service action event (SAE) log for receiving and filtering a plurality of related globally reported errors for a plurality of partitions in the multiprocessing system, wherein the SAE log saves only the first occurrence of the plurality of globally reported errors in an error log; and
a service agent for receiving the error log from the SAE log.

6 The system of claim 5 wherein the SAE log further comprises:
means for receiving the plurality of related globally reported errors from the LPAR multiprocessing system;
means for saving a first occurrence of the plurality of related globally reported errors; and
means for sending the first occurrence to a service agent.

7. The system of claim 6 wherein the SAE log further comprises:
means for saving an identification of each partition that has reported a failure.

8. The system of claim 5 wherein the filtering comprises:
interrogating a plurality of fields of a service event data;
determining if the fields match an open SAE event; and
stripping a partition identifier from the data.

9. A computer readable medium containing program instructions for eliminating duplicate reported errors in a logically partitioned (LPAR) multiprocessing system, the program instructions for:
(a) providing a single source for receiving a plurality of related globally reported errors; and
(b) filtering the plurality of related globally reported errors such that only one call for service is provided.

10. The computer readable medium of claim 7 wherein filtering step (b) comprises the steps of:
(b1) receiving the plurality of related globally reported errors from the LPAR multiprocessing system;
(b2) saving a first occurrence of the plurality of related globally reported errors; and
(b3) sending the first occurrence to a service agent.

11. The computer readable medium of claim 8 wherein the saving step (b2) further comprises the step of:
(b21) saving an identification of each partition that has reported a failure.

12. The method of claim 9 wherein the filtering step (b) comprises the steps of:
(b1) interrogating a plurality of fields of a service event data;
(b2) determining if the fields match an open SAE event; and
(b3) stripping a partition identifier from the data.
